(19) United States
(12) Patent Application Publication
(10) Pub. No.: US 2017/0127506 A1
(43) Pub. Date: May 4, 2017

(54) GENERATION OF DIELECTRIC BARRIER DISCHARGE PLASMA USING A MODULATED VOLTAGE

(71) Applicants: Hamid Reza Ghomi Marzdashty, Tehran (IR); Nasrin Navab Safa, Tehran (IR); Mehrdad Rezaei Golghand, Tehran (IR)

(72) Inventors: Hamid Reza Ghomi Marzdashty, Tehran (IR); Nasrin Navab Safa, Tehran (IR); Mehrdad Rezaei Golghand, Tehran (IR)

(21) Appl. No.: 15/409,457

(22) Filed: Jan. 18, 2017

Related U.S. Application Data
(60) Provisional application No. 62/286,319, filed on Jan. 23, 2016.

(51) Int. Cl. H05H 1/24

(52) U.S. Cl. CPC H05H 1/2406; H05H 2001/2425

(57) ABSTRACT

Modulated power supply includes a first power supply and a second power supply. One from among the first power supply and second power supply supplies a high voltage at a frequency to one electrode of a pair of electrodes of a dielectric barrier discharge (DBD) plasma reactor. The other from among the first power supply and second power supply supplies a high voltage at another, different frequency to the other electrode of the pair of electrodes of the DBD plasma reactor.

CROSS REFERENCE TO RELATED APPLICATION

This application claims the benefit of priority from pending U.S. Provisional Patent Application Ser. No. 62/286,319, filed on Jan. 23, 2016, and entitled “GENERATION OF DIELECTRIC BARRIER DISCHARGE PLASMA USING A MODULATED VOLTAGE” which is incorporated by reference herein in its entirety.

### TECHNICAL FIELD

The present application generally relates to generating Dielectric Barrier Discharge (hereinafter “DBD”) plasma, and more particularly relates to generating DBD plasma applying a modulated voltage.

### BACKGROUND OF THE APPLICATION

Dielectric barrier discharge (DBD) is a promising method to produce non-thermal plasma at atmospheric pressure. It is extensively used in different areas of research and technology such as medicine, biology, surface modification, etc. DBD plasma generally is generated by applying an alternating voltage of several tens of kilo volts between two electrodes, with one of the electrodes covered with a layer of dielectric such as quartz or ceramic. Dielectric layer between the electrodes limits electrical current between the two electrodes to about several milliamperes and prevents an arc from forming.

Several parameters including gas type, dielectric material, dielectric thickness, shape of electrodes, discharge gap, and characteristics of applied voltage, have influence on the function and efficiency of the DBD plasma reactors in various industrial applications and research efforts.

In various applications, for example in applications where a sample is to be treated directly between two electrodes, generation of the DBD plasma at the large electrodes gap (>1cm) is required. Increasing the voltage applied to the electrodes, or use of easy to ionize gases such as helium and argon are two common solutions to generate a stable plasma at a large discharge gap. However, using such gases in the electrode gaps increases the cost of the system. One result can be the designed systems not being easily adopted for industrial and commercial applications. Moreover, at a higher voltage, safety risks can arise and associated costs of protection, e.g., added electrical insulation, can increase.

Therefore, for widening applications and uses of DBD plasma applications, there is a need in the art to generate stable plasma in a large discharge gap, in the presence of air and other available, low cost gases.

### SUMMARY

The following brief summary is not intended to include all features and aspects of the present application, nor does it imply that the application must include all features and aspects discussed in this summary.

The instant application discloses, for example, methods for generating DBD plasma by applying a modulated voltage. An exemplary implementation of the method can include steps of providing a DBD plasma reactor, including a pair of electrodes spaced apart by an electrode gap; and preparing a modulated power supply to provide a modulated voltage to the pair of electrodes.

In one or more general aspects of the present disclosure, the modulated power supply can include at least two individual power supplies. In some example implementations, each of the at least two power supplies may have a pair of output terminals.

According to one or more aspects of the present disclosure, providing a modulated voltage from the at least two power supplies can include connecting and grounding one output of each power supply; connecting another output of each power supply to one electrode of the pair of electrodes, and applying high voltage at different frequencies in each of the at least two power supplies. In an aspect, applying high voltage at different frequencies to each of at least two power supplies can be a simultaneous application. In one or more implementations, such simultaneous application of voltages allows modulation of the applied voltages to the electrodes for generating DBD plasma.

The above example aspects may include one or more additional features. For example, in some implementations, in the first power supply or the second power supply, or in both, high voltage less of than 40 kV may be applied. In one or more implementations, in one of the at least two power supplies, high-frequency high voltage can be applied, while for one another power supply, low frequency high voltage may be applied. In some example implementations, once a pulsed high voltage is applied for one power supply, non-pulsed voltage can be applied by one another power supply.

In some implementations, the pair of electrodes can be spaced apart from each other by a distance of between about 1 to about 40 millimeters. In one or more implementations, the frequency of low-frequency high voltage source can be in the range of between 30 to 60 Hz. In some implementations, the frequency of low frequency high voltage source can be less than 30 kHz.

According to one or more aspects, the electrode gap can include one of easy ionized gases, for example helium, argon, neon, air, oxygen, or combination thereof.

In one or more implementations, the modulating power supply can provide a modulating voltage able to generate stable and dense plasma in the electrode gap of more than 5 mm, while the electrode gap contains air.

In one or more implementations, one electrode of the pair of electrodes can be covered by a dielectric layer in order to provide dielectric barrier discharge plasma reactor.

The instant application discloses, for example, apparatuses for generating DBD plasma, and one example apparatus according to one implementation can include a DBD plasma reactor and a modulated power supply and, in an aspect, the DBD plasma reactor can include a pair of electrodes spaced apart by an electrode gap, and modulated power supply can include a first power supply and a second power supply, wherein the first power supply can include a pair of first power supply outputs. In one implementations, one of the outputs among the pair of first power supply outputs can be connected to one electrode among the pair of electrodes, and the other of the outputs among the pair of first power supply outputs can be connected to a ground, and wherein the second power supply can include a pair of second power supply outputs, wherein one of the outputs among the pair of second power supply outputs can be connected to another electrode among the pair of electrodes, and the other of the outputs among the pair of second power supply outputs can be connected to the ground.

In one or more implementations, the first power supply can be configured to provide, through the one of the outputs among the pair of first power supply outputs that is connected to the one electrode among the pair of electrodes, a high voltage at one from among a low frequency and a high frequency to the one electrode, and the second power supply can be configured to provide, through the one of the outputs among the pair of second power supply outputs that is connected to the other electrode among the pair of electrodes, a high voltage at a the other among the low frequency and the high frequency to the other electrode.

In one or more implementations, the first power supply can be configured to provide, through the one of the outputs among the pair of first power supply outputs that is connected to the one electrode among the pair of electrodes, a high voltage at one from among a pulsed voltage and a sinusoidal voltage to the one electrode, and the second power supply can be configured to provide, through the one of the outputs among the pair of second power supply outputs that is connected to the other electrode among the pair of electrodes, a high voltage at the other among the pulsed voltage and the sinusoidal voltage to the other electrode.

### BRIEF DESCRIPTION OF THE DRAWINGS

This application will be understood more clearly from the following description and the accompanying figures. These figures are given purely by way of an indication and in no way restrict the scope of the application. The figures are:

FIG. 1 illustrates a logical flow of operations in one example process in a method for generating DBD plasma, according to one or more aspects of the present application.

FIG. 2A illustrates a schematic block diagram of one example arrangement to generate DBD plasma, according to one or more aspects of the present disclosure.

FIG. 2B illustrates a schematic block diagram for a method of generating DBD plasma applying modulated voltage, consistent with one and more aspects of the present application.

FIG. 3A illustrates the applied modulated voltage to one of the pair of electrodes, according to one or more aspects of the present disclosure.

FIG. 3B illustrates the applied modulated voltage to one electrode of the pair of electrodes, according to one or more aspects of the present disclosure.

FIG. 3C illustrates the electrical current in the modulated power supply system, according to one or more aspects of the present disclosure.

FIG. 4 illustrates optical emission spectrum of an example of the DBD plasma generated by applying modulated high voltage on the electrode, consistent with one and more aspects of the present disclosure.

FIG. 5A illustrates a view of an example DBD plasma generated in an electrode gap of about 25 mm when a low frequency (about 50 Hz) high voltage (about 25 kV) power supply is applied, according to one or more aspects of the present disclosure.

FIG. 5B is a view of an example the DBD plasma generated in the electrode gap of 25 mm, when the modulated power supply is applied in the electrode gap of 25 mm and applied voltage of 25 kV, according to one or more aspects of the present disclosure.

FIG. 6A is a view of an example of the DBD plasma generated in the electrode gap of 25 mm, when modulated voltage of 25 kV is applied to the electrodes, according to one or more aspects of the present disclosure.

FIG. 6B is a view of an example of the DBD plasma generated in the electrode gap of 35 mm, when modulated voltage of 25 kV is applied to the electrodes, according to one or more aspects of the present disclosure.

FIG. 7A illustrates the electric current in an example system for generating DBD plasma when only low frequency high voltage power supply is used, according to one or more aspects of the present disclosure.

FIG. 7B illustrates the electrical current in an example system for generating DBD plasma, when the modulated voltage is applied, according to one or more aspects of the present disclosure.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

For purposes of explanation, specific nomenclature is set forth to provide a thorough understanding of the present disclosure. However, it will be apparent to one skilled in the art that these specific details are not required to practice the application. Descriptions of specific applications are provided only as representative examples. Upon reading this disclosure, various modifications to the preferred implementations may be readily apparent to one skilled in the art, and the general principles defined herein may be applied to other implementations and applications without departing from the scope of the disclosure. Practices according to concepts disclosed by the present disclosure are not intended to be limited to the implementations shown, are to be accorded the widest possible scope consistent with the principles and features disclosed herein.

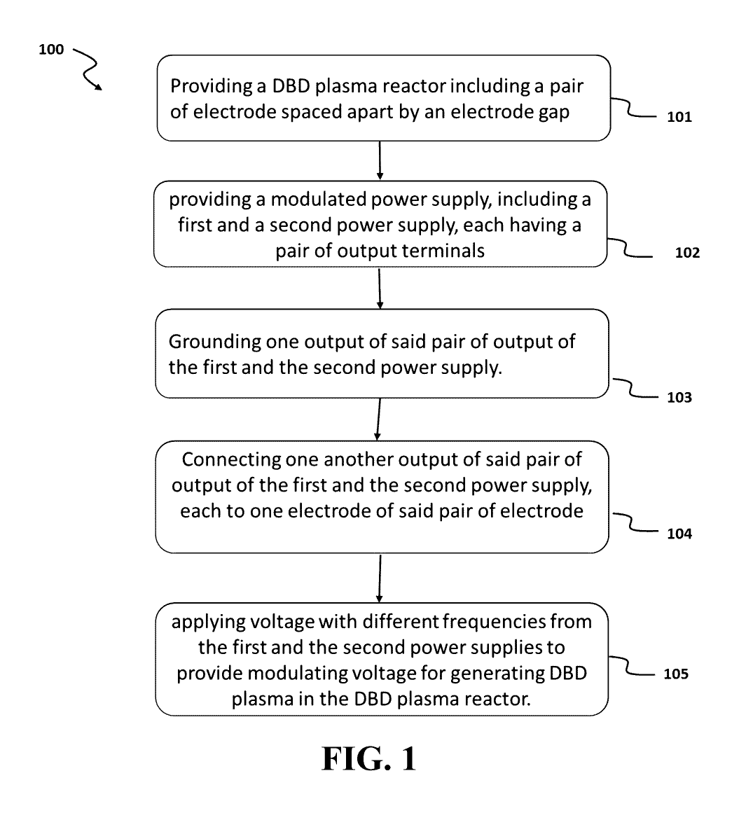

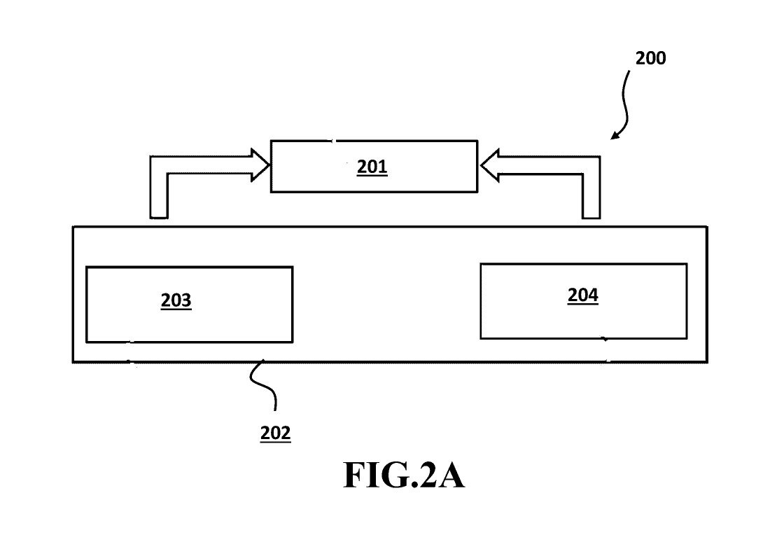

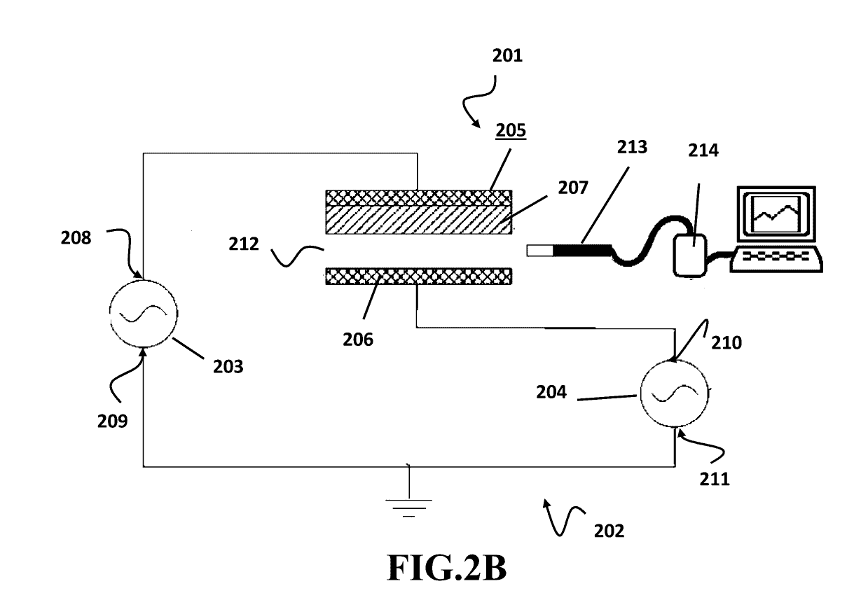

Exemplary implementations consistent with the present disclosure include a method for generating stable and strong DBD plasma by using a modulated voltage source. FIG. 1 is a flow diagram 100 representing a logical flow in processes according to one or more disclosed methods for generating of DBD plasma using a modulated voltage. In an aspect, operations according to the flow 100 can begin at 101, with providing a DBD plasma reactor. One example implementation of a base DBD plasma reactor will be described in greater detail in reference to FIGS. 2A and B.

Operation at 101 can include, for example, providing a pair of electrodes spaced apart by an electrode gap. In certain implementations, at least one of the electrodes can be covered by a dielectric layer, and operations in the flow 100 can then proceed to 102 and provide a modulated power supply. Operations at 102 can include, for example, providing at least two power supplies. For purpose of description, one of the power supplies can be alternatively referenced as the “first power supply, while one another can be referenced as the “second power supply”. Each of these two power supplies (the first and the second power supply) can have a pair of output terminals. The power supplies and their outputs can be configured, as will be described in greater detail in subsequent sections of this disclosure, to provide modulating voltage for the pair of electrodes.

After operations at 102, example operations in the flow 100 can proceed to 103, to ground one output of each power supply pair of output. In an example implementation, the outputs of each power supply can be arranged to be grounded, can be configured to connect to each other before grounding. Example operations at 104 can include connecting the first and the second power supply one another output, to one electrode of the DBD plasma reactor pair of electrodes (one another output of the first power supply to one electrode, and one another output of the second power supply to one another electrode). Upon completing operations at 104, operations in the flow 100 can proceed to step 105, in which high voltage in different frequency from each power supply can be applied simultaneously. In an aspect, such simultaneously applied voltages in the first and the second power supplies can result in providing a modulated voltage to establish the electric field across the electrode gap (labeled as 212 in FIG. 2B) to generate DBD plasma. Persons skilled in the relevant art will recognize, upon reading the present disclosure,that the operation in the flow 100 do not necessarily need to be performed in the order that the labeled graphical boxes are arranged on the drawing. In addition, some operations may be represented by expansion into multiple graphical blocks. Moreover, operations associated with different graphical boxes, although the boxes are illustrated as separate, may be performed in parallel.

As used herein, the phrase “different in frequency,” can encompass—but is not limited to—“low frequency” and “high frequency,” as will be described in greater detail in the later sections of this disclosure.

For illustration purposes, aspects and features of the flow 100 and operations therein may be further described using schematic block diagrams of example implementations illustrated in FIG. 2A and FIG. 2B. Referring now to FIG. 2A, implementations of methods disclosed herein can include providing modulating voltage from a modulated power supply 202 for a DBD plasma reactor 201. The modulated power supply 202 according to operation at 102 (described above) can include, for example, two individual power supplies implementing, respectively, a “first power supply” 203 and a “second power supply” 204. The modulated voltage for DBD plasma reactor 201 can be provided by applying high voltage with different frequency in the aforementioned two power supplies (203 and 204) which are in connection with the DBD plasma reactor 201.

As one illustrative example of one means for carrying out certain operations in practices according to disclosed method, the example basic test setup shown in FIG. 2B was used. In this setup, the DBD plasma reactor 201 can include a pair of electrodes (205 and 206), each electrode can be configured to connect to one output (208 or 209) of the first power supply 203, and one output (210 or 211) of the second power supply 204. According to an example implementation illustrated in FIG. 2B, one of the electrodes, for example electrode 205, can be in connection with one output 208 of the first power supply 203, while another of the electrodes, for example electrode 206, can be in connection with output 210 of the second power supply 204.

In some implementations, the pair of electrodes (203 and 204) are preferably made of an electrically conductive material, for example, a metal or metal alloy having a low resistivity, e.g., less than 1 ohm-cm. Examples of such conductive materials can be stainless steel, copper, aluminum or a conductive catalytic material. In one particular implementation, two aluminum disks can be used as a pair of electrodes. In such an implementation, diameters can be, but are not limited to, about 6 to about 10 centimeters. In order to provide DBD plasma, at least one of the electrodes of the pair of electrodes, for example electrode 205, can be covered by a dielectric layer 207. In certain implementations, the dielectric layer 207 can be formed of, for example, Pyrex™ or silicon dioxide. One non-limiting example thickness can be a thickness in a thickness range of about, for example, 1 mm to 3 mm.

In one general implementation, the first power supply 203 and the second power supply 204 may each be configured to apply high voltage, but with respectively different frequencies. As will be understood by persons of ordinary skill upon reading this disclosure, this implementation can provide a modulated voltage to the pair of electrodes (205 and 206), and this in turn can establish the electric field across the electrode gap 212. For this purpose, connection of outputs of each power supply to the DBD plasma reactor, as well as grounding them, can have importance with respect to providing modulated voltage. Connection of power supplies (203 and 204) outputs (208 and 210) to the pair of electrodes was previously described. Referring now to FIG. 2B, one another output terminals, for example, 209 and 211, can be configured to be grounded. In certain implementation, the latter outputs may be connected to each other before grounding. The term “high voltage,” as used herein, can encompass supply ranges from, for example, greater than about 5 kV up to about 50 kV.

The terms “electrode gap” and “discharge gap” are used herein interchangeably, to reference a distance between the pair of electrodes (205 and 206). One example electrode gap” or “discharge gap” is labeled as 212 in FIG. 2B. In an implementation, the electrode gap, e.g., the electrode gap 212, can be varied from several millimeters to a few centimeters according to the intended applications and applied voltages. Benefits and advantages that can be provided by devices and methods as described above and elsewhere in this disclosure generation of DBD plasma using only air, having high availability and low cost, in contrast to higher cost, less available gases that are more easily ionized, such as helium and argon, that are used in conventional generation of DBD plasma. Generating a stable DBD plasma in a large electrode gap in the presence of cheap gases like air can be a feature desirable for numerous industrial applications. For example, decontamination of food products and fruits using DBD plasma is generally favored to increase the products shelf life and quality.

In one aspect, an implementation of providing the modulated voltage for generating stable and strong DBD plasma can comprise applying voltages (high voltage for example) with different frequencies in each power supply. As an example of such an implementation, one of the power supplies, for example the first power supply 203, can be configured to apply high voltage at a high frequency, while another of the power supplies, for example the second power supply 204, can be configured to apply low-frequency high voltage. In one example of such an implementation, the power supply configured to apply low-frequency high voltage (e.g., the second power supply 204) can be configured to supply the low frequency high voltage as a sinusoidal waveform.

The meaning of the term “differ” in frequencies, as used herein, can include applying a low frequency, as the phrase “low frequency” is used herein, to one of the power supplies concurrent with applying a high frequency, as the phrase “high frequency” is used herein, to another of the power supplies. The meaning of “differ” in frequencies, as used herein, can also include applying a pulsed frequency to one of the power supplies concurrent with applying a sinusoidal high frequency to another of the power supplies.

The term “high frequency,” as used herein, refers to frequencies within a few kilohertz (kHz), preferably between 1 kHz to 40 kHz and more preferably refers to frequencies less than 10 kHz.

The term “low frequency” as used herein refers to frequencies within a few tens of hertz (Hz), preferably less than 100 Hz and more preferably in a range of about 30 to 70 Hz.

In methods and devices according to this disclosure, combining a low-frequency high voltage with the high-frequency high-voltage (high frequency pulses), can provide a higher overvoltage condition (the modulated voltage), which in turn is capable of being higher than may be achieved by applying each power supply high voltage solely. Moreover, in the aforementioned example implementations, the modulated high voltage is provided for the DBD pair of electrodes (205 and 206), and a non-thermal DBD plasma with a fast moving cold streamers is generated across the electrodes gap (labeled as 212 in FIG. 2B).

In one implementation according to the present disclosure, the low-frequency high voltage power supply can act as a carrier. The high voltage can be provided using a high voltage transformer which convert mains electricity (220 V, 50 Hz) to a few tens kV in output. In one and more implementations according to the present disclosure, a 50 Hz high voltage power supply for generating a sinusoidal voltage and a DC pulsed high voltage power supply at the frequency of 7 kHz can be applied. Also, in or more implementations, the wave of the 50 Hz voltage can be used as a carrier voltage on which the 7 kHz can be riding on. In practices according to this disclosure, this technique can help provide a stable DBD plasma in a large electrode gap in the gases with high ionization potential like air.

### EXAMPLE 1

### Modulation Detecting

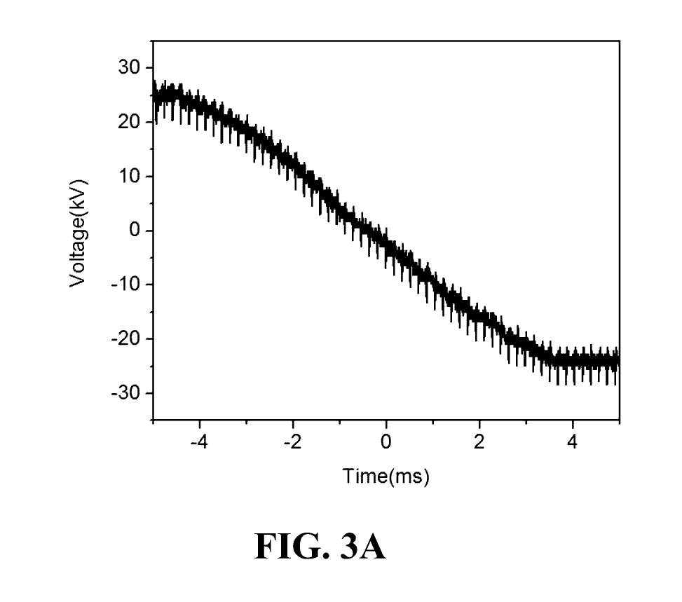

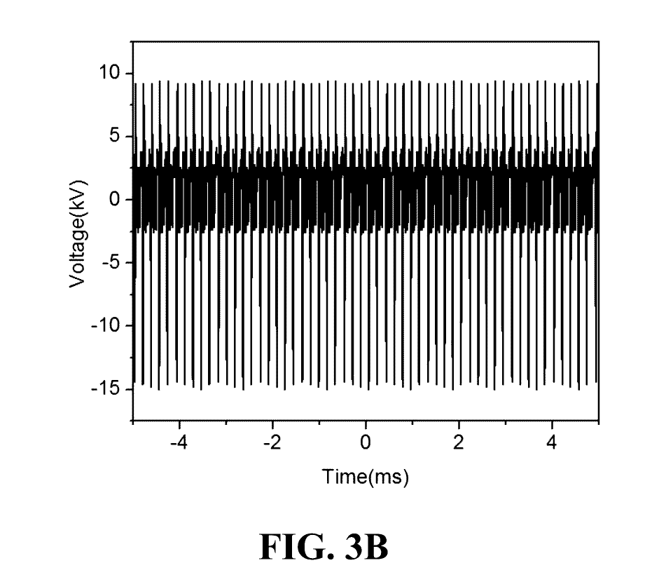

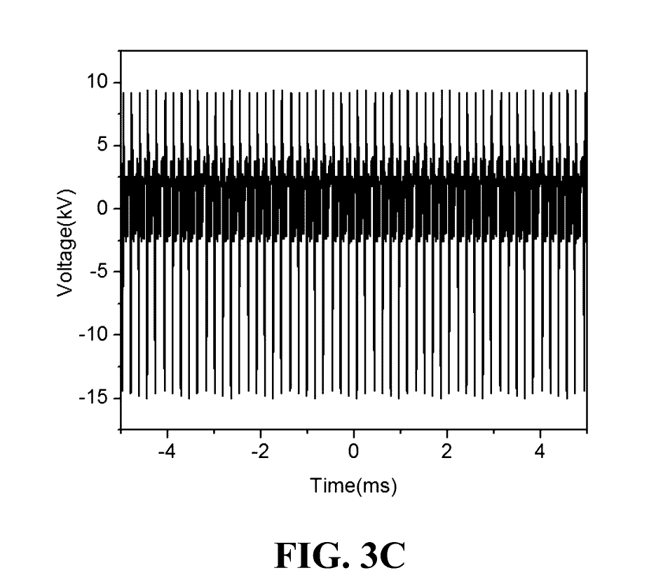

In this example, modulating the provided voltage using two power supplies is illustrated. Referring now to FIGS. 3A to 3C, modulating the provided voltage to the pair of electrodes is illustrated. In particular, FIG. 3A shows the applied voltage to one electrode (205), FIG. 3B shows the applied voltage to one another electrode (206), and FIG. 3C shows the electrical current in the entire modulated power supply system. The applied voltage is measured by a high voltage probe (TEKTRONIX P6015 1:1000) while the current is determined by a current probe (TCP202 TEKTRINIX). The electrical signals are visualized by means of a TEKTRONIX DPO 3012 oscilloscope (100 MH) and then are digitized and transferred to a PC. These diagrams illustrate the modulated voltage on the electrodes which results in the DBD plasma generation between the electrodes. The pulsed waveforms in FIGS. 3A and 3B represent modulated voltage provided in the pair of electrodes 205 and 206, either in low frequency voltage receiving electrode 205 (FIG. 3B), or high frequency voltage receiving electrode 206 (FIG. 3A). The significant peaks created in FIG. 3C can represent generating of DBD plasma in the electrode gap.

### EXAMPLE 2

### Characterization of Generated DBD Plasma

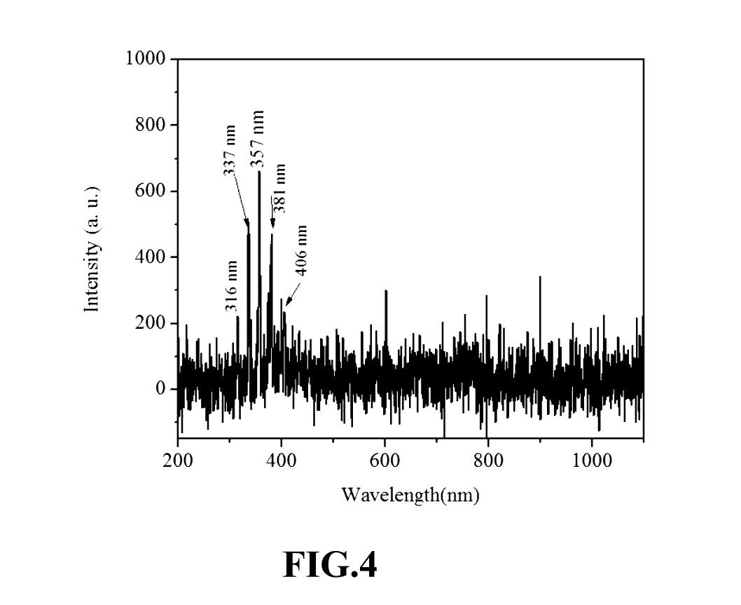

For the test setup, an Ocean Optics Spectrophotometer (model HR 2000) was used as an emission spectrometer to detect the species present in generated DBD plasma by resolving the plasma emission spectrum from about 200 to 1100 nm in wavelength. FIG. 4 illustrates the emission spectrum of the DBD plasma generated by the modulated voltage at the voltage of 25 kV in the electrode gap of 3.5 cm. in order to capture spectrum by the Ocean Optics Spectrophotometer (labeled as 214 in FIG. 2B), an optical fiber (which is labeled as 213 in FIG. 2B) in the distance of about 1-3 centimeters (cm) from the electrode gap can be used. As can be observed in the resulted spectrum, there are several dominant peaks in the near UV region in the interval between 300-450 nanometers (nm) which mainly corresponded to strong emission from N₂ and N₂⁺, or in another words, belong to the transitions of excited nitrogen spices (second positive system of nitrogen C3Πu-B3Πg).

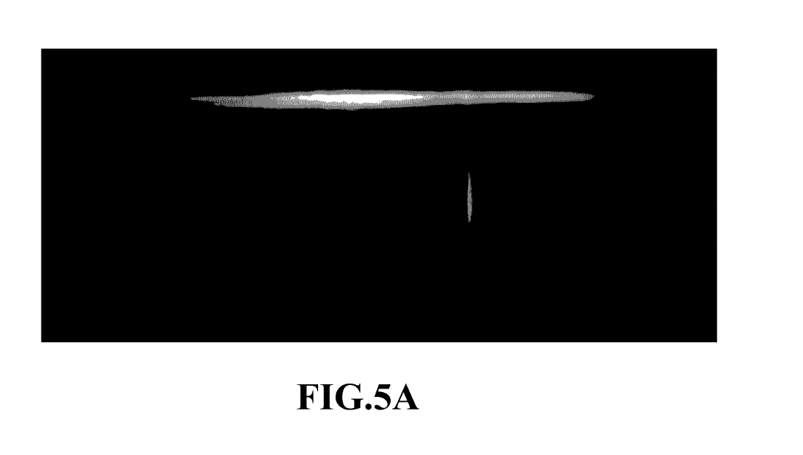

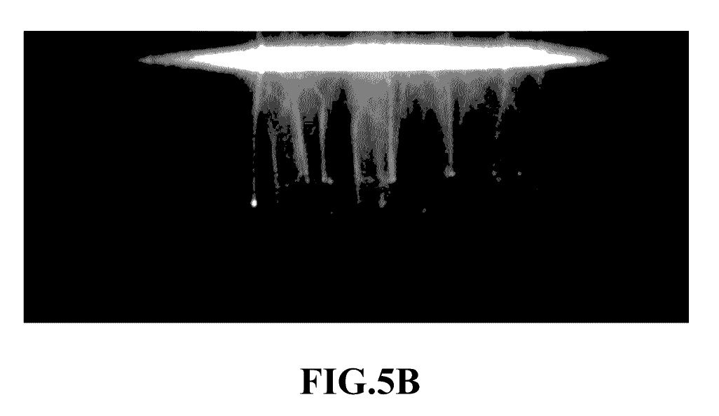

FIG. 5A illustrates the generated DBD plasma in the electrode gap 212 in case of applying low-frequency high voltage (50 Hz sinusoidal voltage), while FIG. 5B illustrates the generated DBD plasma in case of applying modulated voltage to the electrodes. In both implementations, the electrode gap is 2.5 cm and the applied voltage of the low frequency high voltage power supply (the 50 Hz power supply) is 25 kV. Amplitude of modulating power supply is about 10 kV while its frequency is about 7 kHz. In order to provide illustration of applied low frequency high voltage, only one of the power supplies, for example the first power supply 203, with frequency of 50 Hz (201) is applied to one of the pair of electrodes (for example electrode 205), while one other electrode (206 for example) is grounded. Meanwhile, for purposes of illustrating generated DBD plasma in the electrode gap from applying modulated voltage, as described, the pair of electrodes (205 and 206) are connected to the first and the second power supplies (203 and 204) and then modulated voltage is applied to the DBD plasma reactor 201. These images clearly indicate that applying of the modulated voltage can generate more dense, strong and stable plasma when compared the plasma generated when only low frequency (e.g., 50 Hz) high voltage power is supplied at the same amplitude to the electrodes.

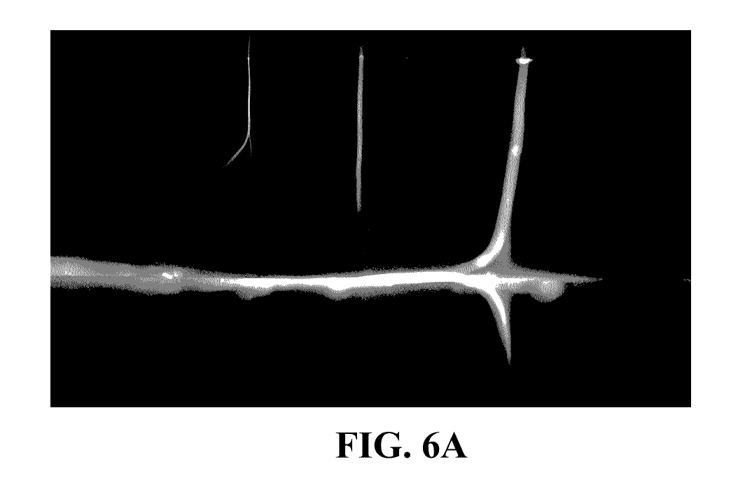

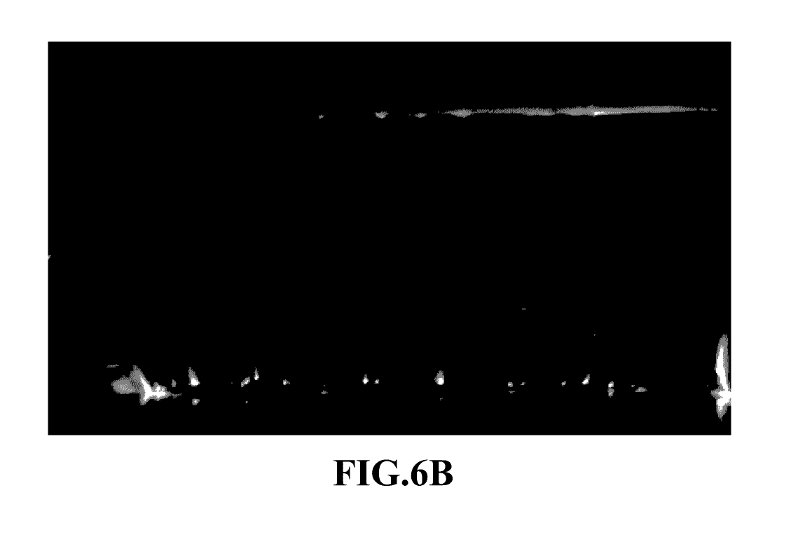

FIG. 6A and FIG. 6B, illustrate generated DBD plasma in the electrode gap using modulated voltage of 25 kV at the electrode gap of 25 mm (FIG. 6A) and at the electrode gap of 35 mm (FIG. 6B). These pictures are taken by the Canon digital camera model “Canon EOS 5D Mark II, Lenz: 100 mm Macro Type L”. Referring to these figures (FIGS. 6A and 6B), although FIG. 6B represents a nearly dense generated DBD plasma at the electrode gap of 35 mm, FIG. 6A clearly represents that, at an electrode gap of 25 mm, a stable and dense plasma can be generated.

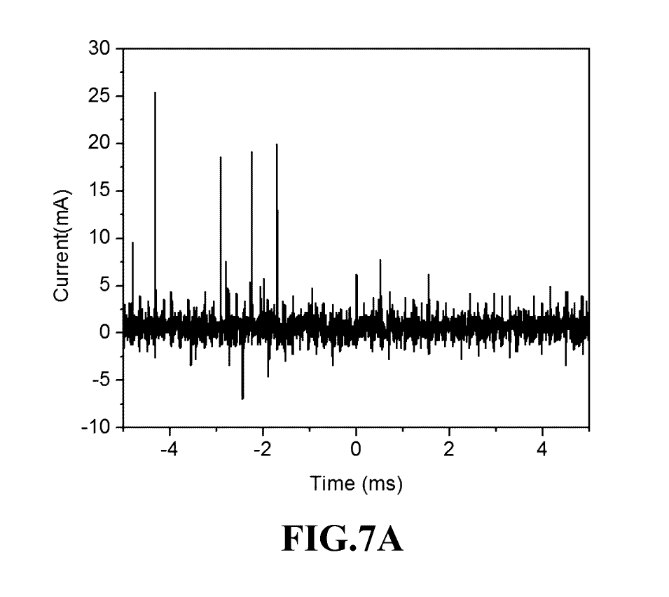

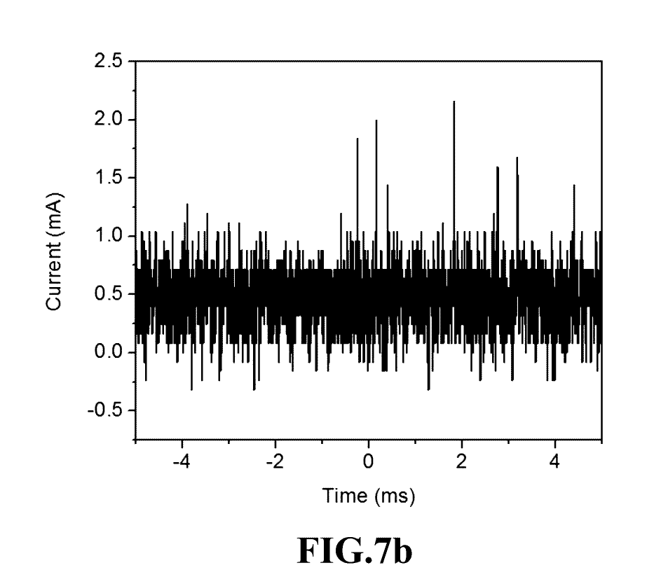

Referring now to FIGS. 7A and 7B, the electric current of generated DBD plasma in case of using low-frequency high voltage (FIG. 7A) and modulated voltage (FIG. 7B) is illustrated, and their measurement setup described in greater details in reference to FIGS. 5A and 5B previously. According to these figures, current in the DBD plasma reactor 201 is in the range of a few mA (milliampere), when only low-frequency high voltage (sinusoidal power supply) is applied to the electrodes, while, in the case of applying modulated voltage, the electric current rises to tens of mA. These findings illustrate the higher current flows and stronger electric discharge in the case of modulated voltage as it is visually previously observed in FIGS. 6A and 6B.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 105 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

What is claimed is:

1. A method for generating stable Dielectric Barrier Discharge (DBD) plasma applying modulated voltage, the method comprising:
providing a DBD plasma reactor, wherein the DBD plasma reactor includes a pair of electrodes spaced apart by an electrode gap; and
preparing a modulated power supply to provide a modulated voltage to the pair of electrodes, wherein the modulated power supply includes at least two power supplies, wherein each of the at least two power supplies includes a pair of outputs.

2. The method according to claim 1, wherein providing a modulated voltage comprises:
grounding an output of each power supply,
connecting another output of each power supply to one electrode of the pair of electrodes; and
simultaneously applying voltages in different frequencies by the at least two power supplies, wherein the simultaneously applied voltages allows modulation of the applied voltage to the electrodes for generating the DBD plasma.

3. The method according to claim 2, wherein grounding one output of each power supply pair of outputs, includes connecting the pair of outputs to one another, before grounding.

4. The method according of claim 2, wherein, for one of the at least two power supplies, high frequency high voltage is applied.

5. The method according of claim 2, wherein for one of the at least two power supplies, a low-frequency high voltage is applied.

6. The method according to claim 1, wherein one of the at least two power supplies includes a pulsed voltage source.

7. The method according to claim 1, wherein one of the at least two power supplies includes a sinusoidal voltage source or a pulsed voltage source.

8. The method of claim 1, wherein the pair of electrodes are spaced apart each other by a distance of between 1 millimeters to 40 millimeters.

9. The method according to claim 2, wherein the frequency of one of the at least two power supplies is in the range of between 30 to 60 Hz.

10. The method according to claim 2, wherein the frequency of one of the at least two power supplies is less than 30 kHz.

11. The method according to claim 2, wherein the voltage of the at least two power supplies is less than 40 kV.

12. The method according to claim 1, wherein the length of the electrode gap is more than 5 mm.

13. The method according to claim 1, wherein the electrode gap contains one or more than easy ionized gases.

14. The method according to claim 13, wherein the ionized gas is selected from a group consisting of helium, argon, neon, air, oxygen, or combination thereof.

15. The method according to claim 1, wherein at least one electrode of the pair of electrodes is covered by a dielectric layer to provide dielectric barrier discharge plasma reactor.

16. An apparatus for generating stable Dielectric Barrier Discharge (DBD) plasma, comprising:
a DBD plasma reactor, wherein the DBD plasma reactor includes a pair of electrodes spaced apart by an electrode gap; and
a modulated power supply, configured to provide a modulated voltage to the pair of electrodes, wherein:
the modulated power supply includes a first power supply and a second power supply,
the first power supply includes a pair of first power supply outputs, wherein one of the outputs among the pair of first power supply outputs is connected to one electrode among the pair of electrodes, and the other of the outputs among the pair of first power supply outputs is connected to a ground, and
the second power supply includes a pair of second power supply outputs, wherein one of the outputs among the pair of second power supply outputs is connected to another electrode among the pair of electrodes, and the other of the outputs among the pair of second power supply outputs is connected to the ground.

17. The apparatus according to claim 16, wherein:
the first power supply is configured to provide, through the one of the outputs among the pair of first power supply outputs that is connected to the one electrode among the pair of electrodes, a high voltage at a low frequency to the one electrode, and
the second power supply is configured to provide, through the one of the outputs among the pair of second power supply outputs that is connected to the other electrode among the pair of electrodes, a high voltage at a high frequency to said other electrode.

18. The apparatus according to claim 16, wherein:
the first power supply is configured to provide, through the one of the outputs among the pair of first power supply outputs that is connected to the one electrode among the pair of electrodes, a high voltage at a high frequency to the one electrode, and
the second power supply is configured to provide, through the one of the outputs among the pair of second power supply outputs that is connected to the other electrode among the pair of electrodes, a high voltage at a low frequency to said other electrode.

19. The apparatus according to claim 16, wherein:
the first power supply is configured to provide, through the one of the outputs among the pair of first power supply outputs that is connected to the one electrode among the pair of electrodes, a sinusoidal voltage to the one electrode, and
the second power supply is configured to provide, through the one of the outputs among the pair of second power supply outputs that is connected to the other electrode among the pair of electrodes, a pulsed voltage to said other electrode.

20. The apparatus according to claim 16, wherein:
the first power supply is configured to provide, through the one of the outputs among the pair of first power supply outputs that is connected to the one electrode among the pair of electrodes, a pulsed voltage to the one electrode, and
the second power supply is configured to provide, through the one of the outputs among the pair of second power supply outputs that is connected to the other electrode among the pair of electrodes, a sinusoidal voltage to said other electrode.
